(19) United States
(12) Patent Application Publication
(10) Pub. No.: US 2009/0213140 A1
(43) Pub. Date: Aug. 27, 2009

(54) MEDICAL SUPPORT CONTROL SYSTEM

(76) Inventors: Masaru ITO, Yokohama (JP); Koichi TASHIRO, Sagamihara (JP)

Correspondence Address: OSTROLENK FABER GERB & SOFFEN, 1180 AVENUE OF THE AMERICAS, NEW YORK, NY, 100368403, US

(21) Appl. No.: 12/037,226

(22) Filed: Feb. 26, 2008

(51) Int. Cl. G09G 5/00

(52) U.S. Cl. 345/629

(57) ABSTRACT

A control device connected to a display manipulation device and a plurality of display devices, comprising: superposition means creating a superposition image that is obtained by superposing drawing information on an image of an input video signal; and output means outputting, to the respective display devices, the superposition image and an image that is different from an image in the display manipulation device.

### BACKGROUND OF THE INVENTION

1. Field of the Invention

The present invention relates to a medical support control system for controlling medical devices and non-medical devices used for operations.

2. Description of the Related Art

Operating systems using medical controllers or the like for controlling medical devices such as endoscopes or the like used for operations have been proposed.

Medical devices to be controlled such as electric knives, aeroperitoneum devices, endoscope cameras, light source devices, or the like are connected to the medical controller (also referred to as MC). Also, a display device, a manipulation panel, or the like is connected to the MC. The manipulation panel includes a display unit and a touch sensor, and is used as a central manipulation device by nurses or the like working in an unsterilized area. The display device is used for displaying endoscope images or the like.

There is audio-visual equipment in the operating room such as a room light, a room camera, an interphone device, a liquid crystal display device, or the like (non-medical devices). The audio-visual equipment is controlled independently or by a non-medical controller (also referred to as an NMC) used for the central control.

Japanese Patent Application Publication No. 2006-000536, for example, discloses an operating system, comprising:

a first controller connected to a medical device provided in an operating room;

a second controller connected to a non-medical device provided in the operating room; and

manipulation instruction input means transmitting the content of a manipulation instruction to the first controller when a manipulation instruction for the medical device or the non-medical device is input. The first controller transmits to the second controller a first control signal in accordance with the manipulation instruction of the non-medical device input into the manipulation instruction means. The second controller converts the first control signal into a second control signal used for controlling the non-medical device, and transmits the second control signal to the non-medical device. Thereby, the operating system and a non-medical system work together, and the operating person himself/herself or the like can manipulate the non-medical devices.

### SUMMARY OF THE INVENTION

A control device connected to a display manipulation device and a plurality of display devices, comprising:

superposition means creating a superposition image that is obtained by an image of an input video signal and drawing information; and

output means outputting, to the respective display devices, the superposition image and an image that is different from an image in the display manipulation device.

The control device is a medical support control system, and

the input video signal is a medical image.

Also, on the basis of an output destination set by the display manipulation device, the output means outputs, to the respective display devices, a synthetic image obtained by synthesizing the superposition image and the image.

Also, even when a superposition image creation window displayed in a manipulation window in the display manipulation device has transited to another window, the output means causes the display device to display the synthetic image.

Also, even when a superposition image creation window displayed in a manipulation window in the display manipulation device has transited to another window, the output means continues to cause the display device to display the synthetic image on the basis of the drawing information stored in the drawing information storage means.

### BRIEF DESCRIPTION OF THE DRAWINGS

FIG. 1 shows an entire configuration of a medical device control system according to the present embodiment;

FIG. 2 is a block diagram showing an entire configuration of a medical support control system 100 according to the present embodiment;

FIG. 3 is a side view showing a configuration of the rear panel of an NMC according to the present embodiment;

FIG. 4 shows a configuration of a video interface card;

FIG. 5 shows a configuration of a switching control card;

FIG. 6 shows a configuration of a video processing card;

FIG. 7 is a block diagram showing a configuration of a touch panel card;

FIG. 8 shows images created by synthesizing a GUI image and a medical image by using a TPC;

FIG. 9 shows images created by synthesizing the GUI image (including a drawing image) and a medical image by using the TPC;

FIG. 10 shows images created by synthesizing the GUI image and a medical image by using the TPC;

FIG. 11 shows images created by synthesizing the GUI image displayed in the TP and a medical image (including drawing image) displayed in a display device;

FIG. 12 is a block diagram showing a flow of respective image signals when editing is performed; and

FIG. 13 is a flowchart for a process of synthesizing the GUI image and the medical image.

### DESCRIPTION OF THE PREFERRED EMBODIMENTS

Hereinafter, the embodiments of the present invention will be explained in detail, referring to the drawings.

A medical support control system according to the present embodiment includes a medical device control system and a non-medical device control system. The medical device control system includes a plurality of medical devices and a medical controller for controlling these medical devices. The non-medical device control system includes non-medical devices (that may further include medical devices) that are used for operations, and a non-medical controller for controlling these non-medical devices.

An endoscopic operating system will be explained as an example of the medical device control system.

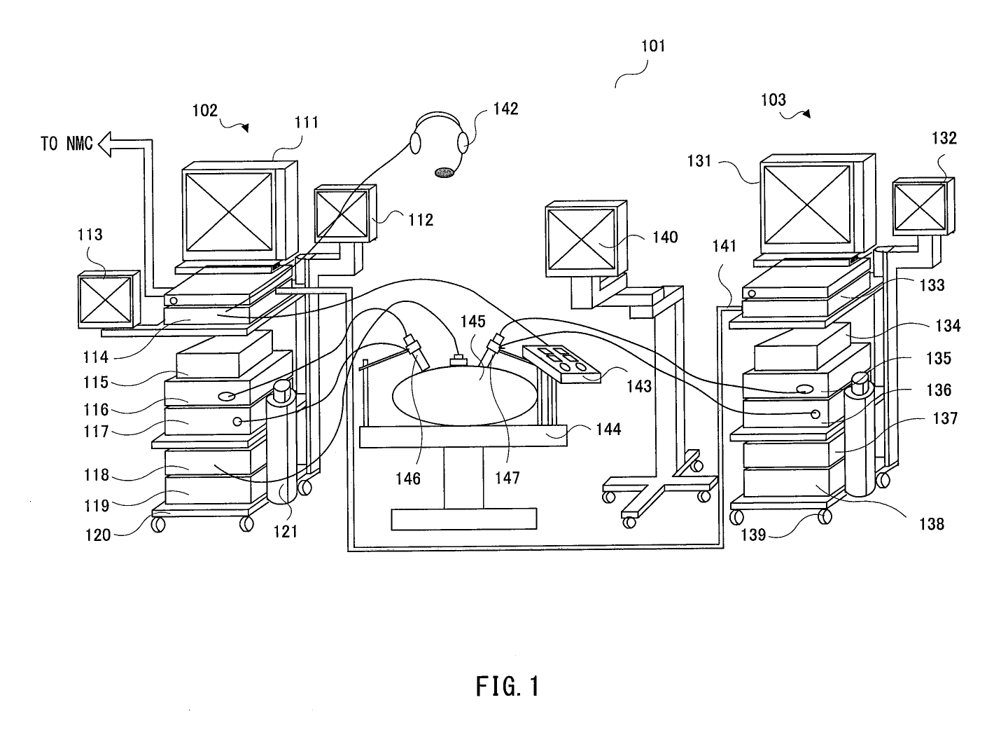

FIG. 1 shows an entire configuration of the medical device control system according to the present embodiment.

An endoscopic operating system is shown as a medical device control system 101. In the operating room, a first endoscopic operating system 102 and a second endoscopic operating system 103 beside a bed 144 on which a patient 145 is laid and a wireless remote controller 143 for the operating person are provided.

The endoscopic operating systems 102 and 103 respectively have first and second trolleys 120 and 139 each including a plurality of endoscope peripheral devices used for observation, examination, procedures, recoding, and the like. Also, an endoscope image display panel 140 is arranged on a movable stand.

On the first trolley 120, an endoscope image display panel 111, a central display panel 112, a central manipulation panel device 113, a medical controller (MC) 114, a recorder 115, a video processor 116, an endoscope light source device 117, an aeroperitoneum unit 118, and an electric knife device 119 are arranged.

The central manipulation panel device 113 is arranged in an unsterilized area to be used by nurses or the like in order to manipulate the respective medical devices in a centralized manner. This central manipulation panel device 113 may include a pointing device such as a mouse, a touch panel, or the like (not shown). By using the central manipulation panel device 113, the medical devices can be managed, controlled, and manipulated in a centralized manner.

The respective medical devices are connected to the MC 114 via communication cables (not shown) such as serial interface cables or the like, and can have communications with one another.

Also, a headset-type microphone 142 can be connected to the MC 114. The MC 114 can recognize voices input through the headset-type microphone 142, and can control the respective devices in accordance with the voices of the operating person.

The endoscope light source device 117 is connected to a first endoscope 146 through a light-guide cable used for transmitting the illumination light. The illumination light emitted from the endoscope light source device 117 is provided to the light guide of the first endoscope 146 and illuminates the affected areas or the like in the abdomen of the patient 145 into which the insertion unit of the first endoscope 146 has been inserted.

The optical image data obtained through the camera head of the first endoscope 146 is transmitted to a video processor 116 through a camera cable. The optical image data undergoes signal processing in a signal processing circuit in the video processor 116, and the video signals are created.

The aeroperitoneum unit 118 provides CO₂ gas to the abdomen of the patient 145 through a tube. The CO₂ gas is obtained from a gas tank 121.

On the second trolley 139, an endoscope image display panel 131, a central display panel 132, a relay unit 133, a recorder 134, a video processor 135, an endoscope light source device 136, and other medical devices 137 and 138 (such as an ultrasonic processing device, a lithotripsy device, a pump, a shaver, and the like) are arranged. These respective devices are connected to the relay unit 133 through cables (not shown), and can communicate to one another. The MC 114 and the relay unit 133 are connected with each other through the relay cable 141.

The endoscope light source device 136 is connected to a second endoscope 147 through the light-guide cable for transmitting the illumination light. The illumination light emitted from the endoscope light source device 136 is provided to the light guide of the second endoscope 147, and illuminates the affected areas or the like in the abdomen of the patient 145 into which the insertion unit of the second endoscope 147 has been inserted.

The optical image data obtained through the camera head of the second endoscope 147 is transmitted to a video processor 135 through a camera cable. The optical image data undergoes signal processing in a signal processing circuit in the video processor 135, and the video signals are created. Then, the video signals are output to the endoscope image display panel 131, and endoscope images of the affected areas or the like are displayed on the endoscope image display panel 131.

Further, the MC 114 can be controlled by the operating person manipulating the devices in the unsterilized area. Also, the first and second trolleys 120 and 139 can include other devices such as printers, ultrasonic observation devices, or the like.

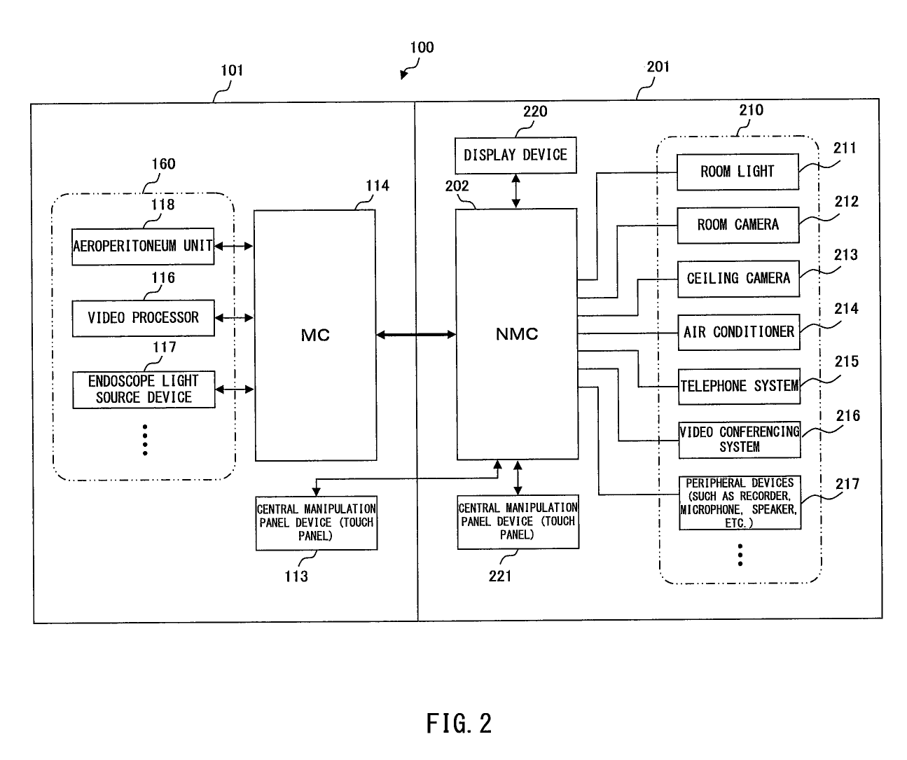

FIG. 2 is a block diagram showing an entire configuration of a medical support control system 100 according to the present embodiment. As described above, the medical support control system 100 includes the medical device control system 101 and a non-medical device control system 201. A detailed configuration of the medical device control system 101 is as shown in FIG. 1. However, in FIG. 2, the medical device control system 101 is shown in a simplified manner for simplicity of explanation.

In FIG. 2, a medical device group 160 is a group of medical devices that are directly connected to the medical controller 114 or are indirectly connected to the MC 114 via the relay unit 133. Examples of the devices included in the medical device group 160 are the aeroperitoneum unit 118, the video processor 116, the endoscope light source device 117, the electric knife device 119, and the like.

The central manipulation panel device 113 has a touch panel, and in accordance with the information input into the touch panel, the devices connected to the MC 114 or a non-medical device controller (NMC) 202 that will be described later can be manipulated.

The non-medical control system 201 includes the NMC 202 connected to the MC 114 through a communication cable or the like, and a non-medical device group 210. In this configuration, the NMC 202 can transmit and receive, through an image cable, the video signals to and from the medical device group 160 connected to the MC 114.

The NMC 202 controls the non-medical devices (including the audio-visual devices) connected thereto. As shown in FIG. 2, the non-medical device group 210 connected to the NMC 202 according to the present embodiment consists of a room light 211, a room camera 212, a ceiling camera 213, an air conditioner 214, a telephone system 215, a conference system 216 to be used for individuals in remote places (referred to as a video conference system hereinafter), and other peripheral devices 217. Further, a display device 220 and a central manipulation panel device 221 are connected to the NMC 202.

Also, the non-medical device group 210 includes equipment such as light devices provided in the operating room in addition to the AV devices used for recording and reproducing image data.

The display device 220 is a plasma display panel (PDP) or a liquid crystal display (LCD) device, and displays images of the predetermined device or images of the devices selected by nurses or the like through the central manipulation panel device 221. The room light 211 is a device that illuminates the operating room. The room camera 212 is used for shooting images of the situations in the operating room. The ceiling camera 213 is a camera suspended from the ceiling whose positions can be changed. The conference system 216 is a system that displays images and transmits voices of nurses or the like in the medical office or the nurse stations, and enables conversations with them. The peripheral devices 217 are, for example, a printer, a CD player, a DVD recorder, and the like. The central manipulation panel device 221 has a touch panel that is the same as that included in the central manipulation panel device 113, and controls the respective AV devices connected to the NMC 202. The central manipulation panel devices 113 and 221 are referred to as TPs hereinafter.

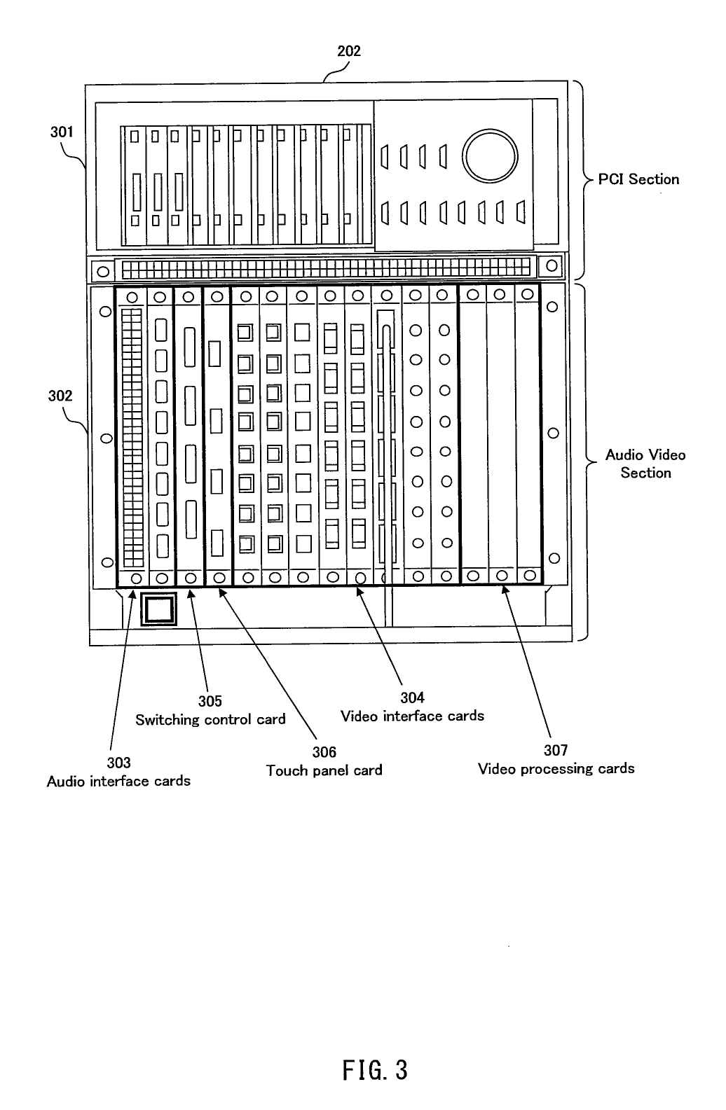

FIG. 3 is a side view showing a configuration of the rear panel of the NMC 202 according to the present embodiment.

The NMC 202 includes a PCI section 301 and an audio/video section 302.

The PCI section communicates with devices connected to the external environment, and has cards having relay devices and the functions of the RS232C, the digital I/O, the ether net, and the modem in order to control devices in the non-medical device group 210 that are connected to other cards that will be described later.

The audio/video section 302 includes audio interface cards 303 (AIC), video interface cards 304 (VIC), a switching control card 305 (SCC), a touch panel card 306 (TPC), and video processing cards 307 (VPC). Additionally, the respective cards included in the audio/video section 302 of the NMC 202 are detachable.

The AICs 303 are inserted into a plurality of slots for the AICs 303 in order to receive, process (amplify, for example), and output audio signals input from a device such as an IC or the like that includes a transmitter/receiver existing in the external environment.

Each of the VICs 304 creates, when a video signal is input into it from the external environment, a common signal, said common signal being different from any of the video signals input into and output from the VICs 304 and said common signal being used commonly in the NMC 202.

In this configuration, examples of the video signals include an HD/SD-SDI (High Definition/Standard Definition-Serial Digital Interface) signal, an RGB/YPbPr signal, an S-Video signal, a CVBS (Composite Video Blanking and Sync) signal, a DVI-I (Digital Visual Interface Integrated) signal, an HDMI (High-Definition Multimedia Interface) signal, and the like.

Also, the VIC 304 has a function of inversely converting common signals into video signals appropriate to the output destination. Further, the respective VICs 304 can be inserted into a plurality of slots provided for the VICs 304. Also, all the VICs 304 can have a common interface connector. Also, when the power is in an off state, the VICs 304 perform switching to a path in which input video signals are directly output without being converted.

The SCC 305 selects the VIC 304 as the output destination in accordance with instructions given from the external environment. Also, the SCC 305 obtains VIC-related information including identification information used for identifying the VICs 304 and position information specifying the positions of the corresponding VICs 304. The identification information is obtained from the VICs 304. Then, the SCC 305 detects, on the basis of the VIC-related information, the position of the VIC 304 as the output destination set in accordance with the instruction given from the external environment, and selects the VIC 304 or the VPC 307 as the output destination for the common signal.

The SCC 305 is connected to the TP 221 via, for example, the TPC 306, and sets, in the SCC 305, which of the VICs 304 or which of the VPCs 307 to select as the output destination.

The VPC 307, in accordance with the video signals expressed by the common signals, processes the input signals into video signals appropriate to the selected VIC 304.

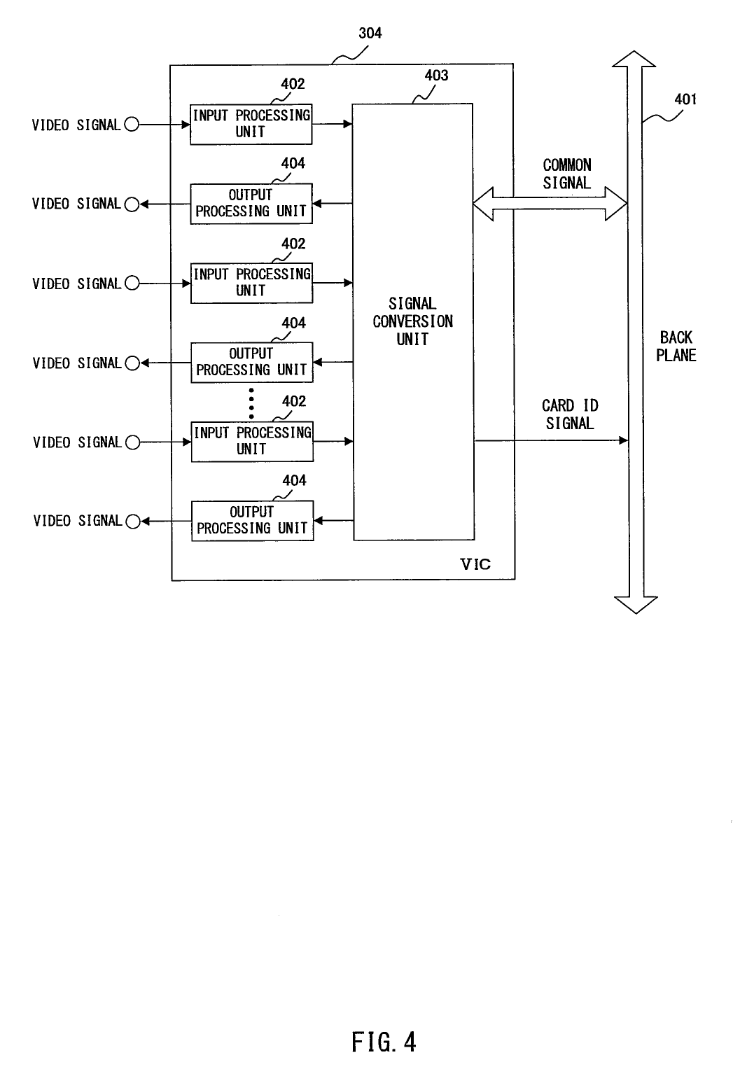

FIG. 4 shows a configuration of the VIC 304.

The VIC 304 is attached to a back plane 401, and includes an input processing unit 402, a signal conversion unit 403, and an output processing unit 404. In this configuration, the back plane 401 includes slots into which the audio interface cards (AIC) 303, the video interface cards (VIC) 304, the switching control card (SSC) 305, a touch panel card (TPC) 306, and the video processing cards (VPC) 307 are inserted. These cards perform communications via the back plane 401.

The VICs 304 transmit and receive, through the back plane 401, the common signals that are obtained by converting the video signals by using the signal conversion unit 403, the common signals input through the cards other than the VICs 304, the identification information for identifying the VICs 304, and the position information for specifying the positions of the slots into which the VICs 304 have been inserted.

The input processing unit 402 receives the video signals output from devices (medical devices and non-medical devices) that are connected to the MC 114 and the NMC 202 and are used for outputting video signals, and transfers the received video signals to the signal conversion unit 403.

The signal conversion unit 403 converts the common signal, said common signal being different from any of the video signals input into and output from the VICs 304 and said common signal being used commonly in the NMC 202, into video signals, and vice versa.

In other words, the signal conversion unit 403 converts the video signal input from the input processing unit 402 into the common signals, and outputs the common signals to the back plane 401. Also, the signal conversion unit 403 obtains the common signals input into the VICs 304 via the back plane 401, and converts the obtained signals into video signals appropriate to the selected VIC 304.

Also, the signal conversion unit 403 outputs, via the back plane 401, VIC-related information (a card ID signal) consisting of the identification information used for identifying the VIC 304 and the position information specifying the position of the slot into which the VIC 304 has been inserted.

The output processing unit 404 outputs the video signals obtained by the conversion of the common signals by using the signal conversion unit 403.

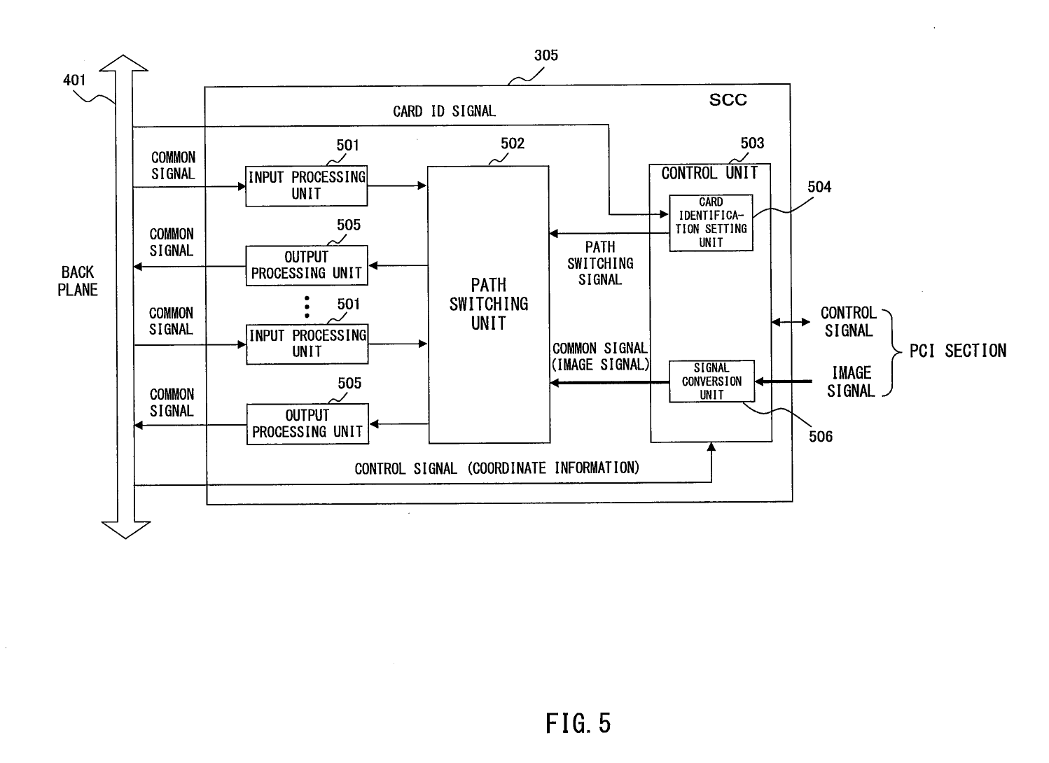

FIG. 5 shows a configuration of the SCC 305.

The SCC 305 is attached to the back plane 401, includes an input processing unit 501, a path switching unit 502, a control unit 503, and an output processing unit 505, and switches the paths for the serialized common signals.

The input processing unit 501 receives the common signals input from the back plane 401 and transfers the received signals to the path switching unit 502.

The path switching unit 502 determines the paths for the common signals to be transmitted to the output-destination VIC 304 in accordance with the path switching signals output from the control unit 503. Also, it determines the path for the common signals to be transmitted to the output-destination VPC 307 in accordance with the path switching signal when image processing is to be performed in the VPC 307. Also, it determines the path for the common signals to be transmitted to the VIC 304 after the image processing in the VPC 307.

The control unit 503 has a card identification setting unit 504 and a signal conversion unit 506, transfers the control signals input from an external connection device to the PCI section 301, and obtains the control signal input from the PCI section 301 in order to control the respective units in the SCC 305.

The card identification setting unit 504 in the control unit 503 outputs path switching signals to be used for determining the output path to the output-destination VIC 304 and the VPC 307 on the basis of the identification information and position information of the VIC-related information (card ID signal) and the selection information of the output-destination VIC 304 and VPC 307 set in accordance with the control signal transmitted from the external connection device.

In order to perform setting from the external environment, setting information for the output-destination VIC 304 is set in the card identification setting unit 504 from, for example, the TPs 113 and 221 in order to cause the input-destination VIC 304 and the output-destination VIC 304 to correspond to each other. By establishing this correspondence, the position of the output-destination VIC 304 is detected from the VIC-related information in order to determine the output-destination VIC 304 for the common signals.

The signal conversion unit 506 obtains image signals input through the PCI section 301, and converts the signals into common signals in order to transfer the converted signals to the path switching unit 502.

The output processing unit 505 outputs, to the output-destination VIC 304 set in the above step, the common signals output from the path switching unit 502.

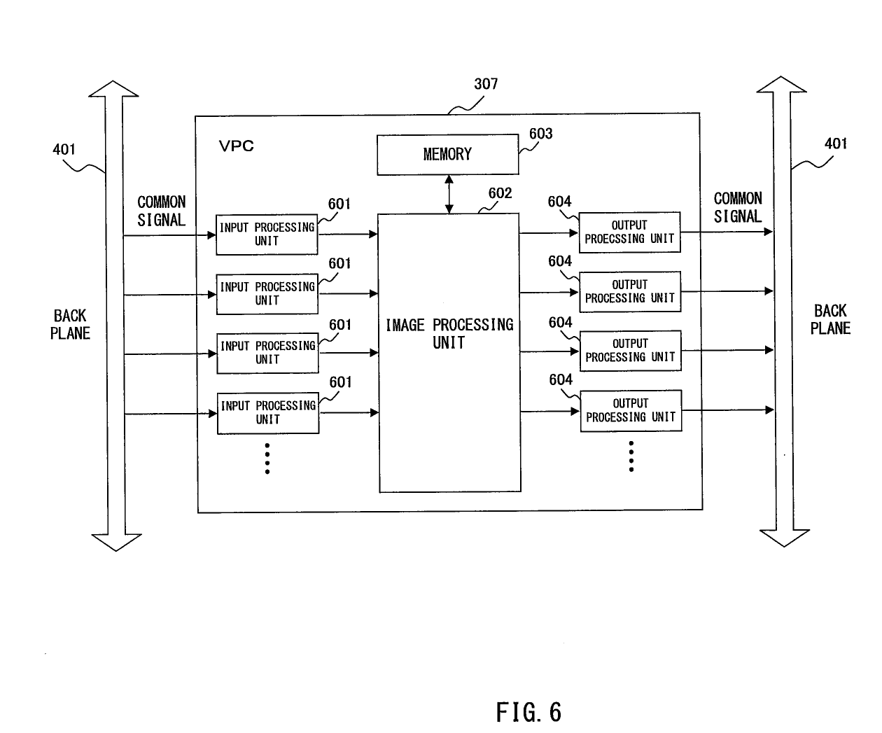

FIG. 6 shows a configuration of a VPC 307.

The VPCs are attached to the back plane 401, and include an input processing unit 601, an image processing unit 602, a memory device 603, and an output processing unit 604.

The input processing unit 601 receives the common signals input from the back plane 401, and transfers the received common signals to the image processing unit 602.

The image processing unit 602, on the basis of the video signals expressed by the common signals, processes the signals into video signals appropriate to the selected VIC 304, and also holds the common signals input from the input processing unit 601 in the memory device 603, and performs image processing on the held common signals in order to output the signals. It is also possible that the common signals undergo the image processing after being converted into the prescribed video signals.

The above image processing includes, for example, the de-interlacing, the rate control, the scaling, the mirror, the rotation, the picture in picture (PIP), the picture out picture (POP), and the like.

The output processing unit 604 transfers, to the SCC 305 via the back plane 401, the common signals that have undergone the image processing performed by the image processing unit 602.

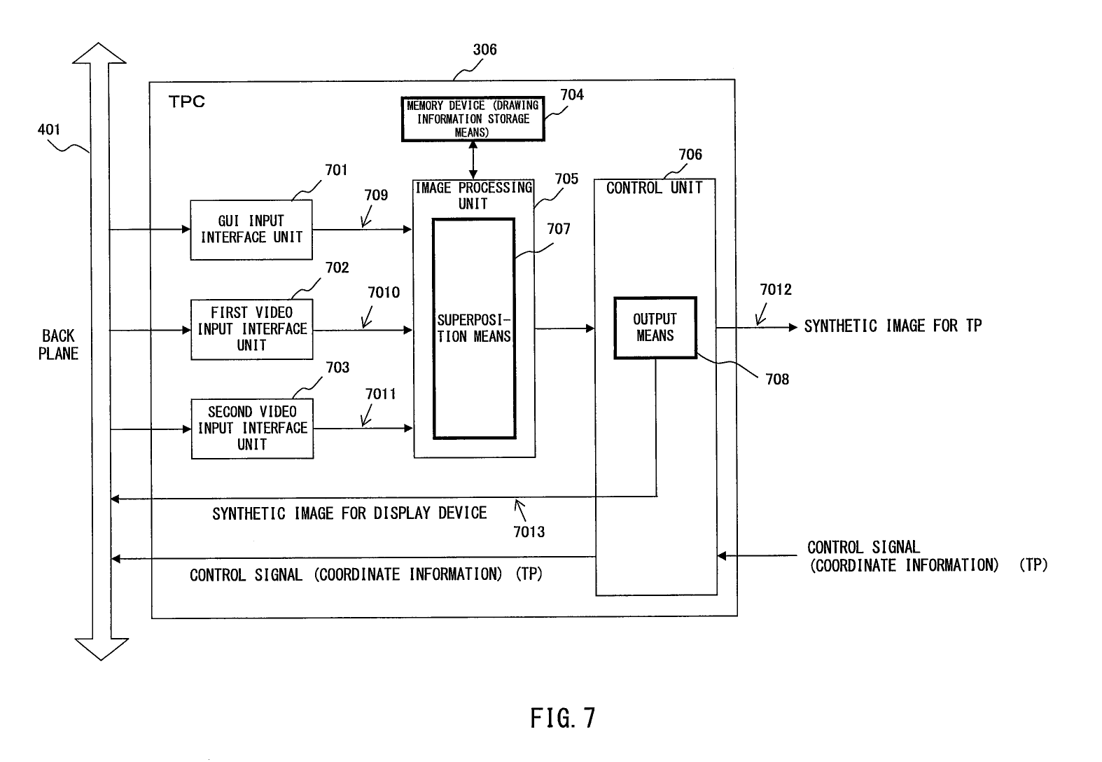

FIG. 7 shows a configuration of the touch panel card 306.

The TPC 306 is included in the back plane 401, and has a function of performing image processing in accordance with instructions given from the TPs 113 and 221.

The TPC 306 includes a GUI input interface unit 701, a first video input interface unit 702, a second video input interface unit 703, a memory device 704 (drawing information storage unit), an image processing unit 705, and a control unit 706.

The GUI input interface unit 701 is an interface used for obtaining, via the SCC 305 and the back plane 401, window layout information (hereinafter, referred to as a GUI (Graphical User Interface) window) created in the PCI section 301, and for outputting the information to the image processing unit 705.

The first video interface unit 702 and the second video interface unit 703 obtain a medical image from the medical device group 160, and output the obtained data to the image processing unit 705. In this configuration, the medical images are images obtain by endoscopes 146 and 147 or by other medical devices (such as an X-ray imaging machine).

In this configuration, the medical images are input into the VIC 304 as video signals, are converted into common signals in the VIC 304, and are input into the SCC 305. Thereafter, the medical images that have been converted into the common signals are output to the output-destination VPC 307 in accordance with the setting in the SCC 305, undergo image processing in the VPC 307, and are input into the first video input interface unit 702 and the second video input interface unit 703.

The memory device 704 stores the GUI images (image signals) obtained through the GUI input interface unit 701, the medical images obtained through the first video interface unit 702 or the second video interface unit 703, or the images processed in the image processing unit 705. Also, it stores drawing information (that will be referred to later) that is transferred together with the GUI images.

Also, when a portion of the GUI image overlaps with the image to be output to the display device 220, the overlapping portion of the GUI image is deleted, and the image to be output to the display device 220 is stored. An example of an overlapping portion of the GUI image is a menu bar.

The image processing unit 705 performs image processing on the respective images obtained through the GUI input interface unit 701, the first video input interface unit 702, and the second video input interface unit 703, and transfers the image-processed images to the control unit 706. Also, it includes the medical images in a prescribed region in the GUI images, and creates synthetic images by synthesizing the GUI images and the medical images.

Superposition means 707 creates a superposition image by superposing the drawing information on the medical images.

The control unit 706 directly outputs the images that were image-processed by the TP 221. Also, the control unit 706 is a device used for controlling the entirety of the TPC 306.

Output means 708 outputs the synthetic images for the display device to the display device 220, and outputs the synthetic images for the TP to the TPs 113 and 221.

Also, the superposition means 707 and the output means 708 may be provided in different blocks from the blocks for the image processing unit 705, and the control unit 706.

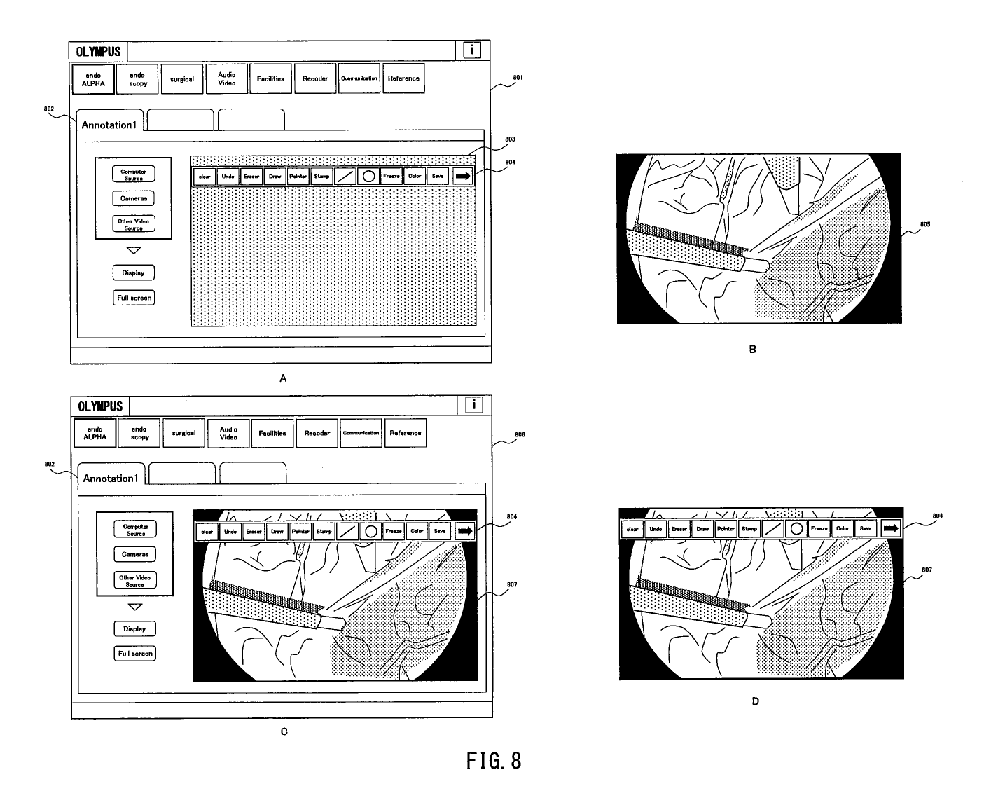

A GUI image 801 (FIG. 8A) is an image of an output 709 of the GUI input interface unit 701. In the example of FIG. 8, the GUI image 801 has an “Annotation” selection switch 802 used to select an edit window (for example, a superposition image creation window), an image region 803 for outputting medical images, and an edit operation selection section 804 that is a “menu bar” for selecting an edit operation of the medical devices.

A medical image 805 (FIG. 8B) is an image of an output 7010 of the first video input interface unit 702. A medical image 805 is a single medical image input from the VIC 304. Also, the medical image may be an image that was image-processed by the VPC 307.

A synthetic image 806 for the TP (FIG. 8C (GUI image+medical image)) is an image of an output 7012 from the control unit 706, and is an image created by synthesizing the GUI image 801 obtained through the GUI input interface unit 701 and the medical image 805 obtained through the first video input interface unit 702. The synthetic image 806 is displayed in the TPs 113 and 221.

A synthetic image 807 for the display device (FIG. 8D (medical image+image)) is an image of an output 7013 of the output means 708, and is an image to be output to the display device 220.

In this configuration, the edit operation selection section 804 has selection switches such as “clear”, “undo”, “eraser”, “draw”, “pointer”, “stamp”, “straight line”, “circle”, “freeze”, “color”, “save”, or the like. Pressing “Clear” clears all the drawing images. Pressing “undo” returns what was done to the previous state. Pressing “eraser” erases only a portion of the selected drawing image. Pressing “draw” performs drawing by following a trace of the pointer. Pressing “pointer” changes the thickness of the lines drawn. Pressing “stamp” draws a time stamp or figures peculiar to users. Pressing “straight line” draws a line between two points selected. Pressing “circle” draws circles or ovals. Pressing “freeze” fixes the image. Pressing “color” changes the colors of the lines or circles drawn. Pressing “save” saves the current image.

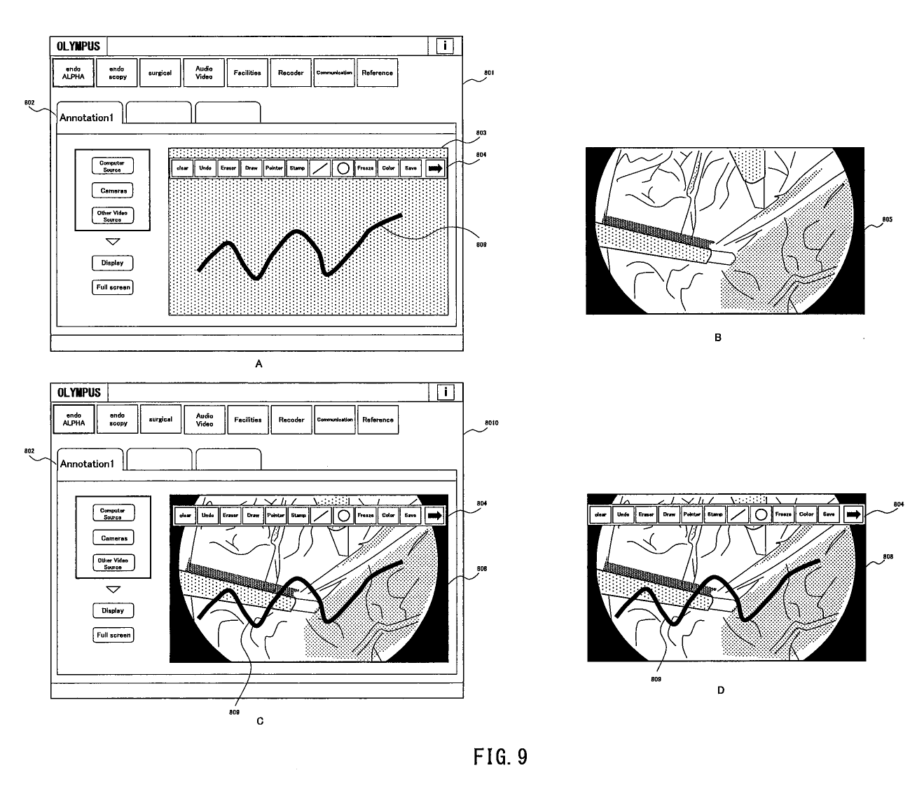

The GUI image 801 (FIG. 9A) is an image of the output 709 of the GUI input interface unit 701. In the example of FIG. 9, the GUI image 801 has the “Annotation” selection switch 802 for selecting the edit window, the image region 803 for outputting the medical images, and the edit operation selection section 804 that is the menu bar for selecting the manner of editing the medical images. Also, a drawing image 809 is displayed in the image region 803. The drawing image 809 is a figure drawn by using the function of the edit operation selection section 804.

The drawing image 809 is drawn by the users through the TPs 113 and 221, and the information (coordinate information) of the drawing image is transferred to the PCI section 301. Then, in the PCI section 301, a drawing image (drawing information) is created on the basis of the information, and the drawing image 809 is displayed after being transferred to the TPC 306 together with the GUI images.

FIG. 9B shows the same image as that shown in FIG. 8B, and it is an image of the output 7010 from the first video input interface unit 702. Also, the medical image 805 is a single medical image input from the VIC 304. Also, the medical image may be an image that was image-processed by the VPC 307.

FIG. 9C shows an image of the output 7012 of the control unit 706, and is an image created by synthesizing the GUI image 801 obtained through the GUI input interface unit 701 and the medical image 805 obtained through the first video input interface unit 702 by using the image processing unit 705 or the like.

Also, FIG. 9C shows an image displayed in the TPs 113, 221, or the like. In the image region 803, the superposition image 808 obtained by superposing the medical image 805 and the drawing image 809 is displayed. Also, the edit operation selection section 804 is displayed on the superposition image 808.

FIG. 9D shows an image to be output to the display device 220 (superposition image 808 (FIG. 9D (medical image+drawing image)) and the edit operation selection section 804), and is an image of the output 7013 of the output means 708.

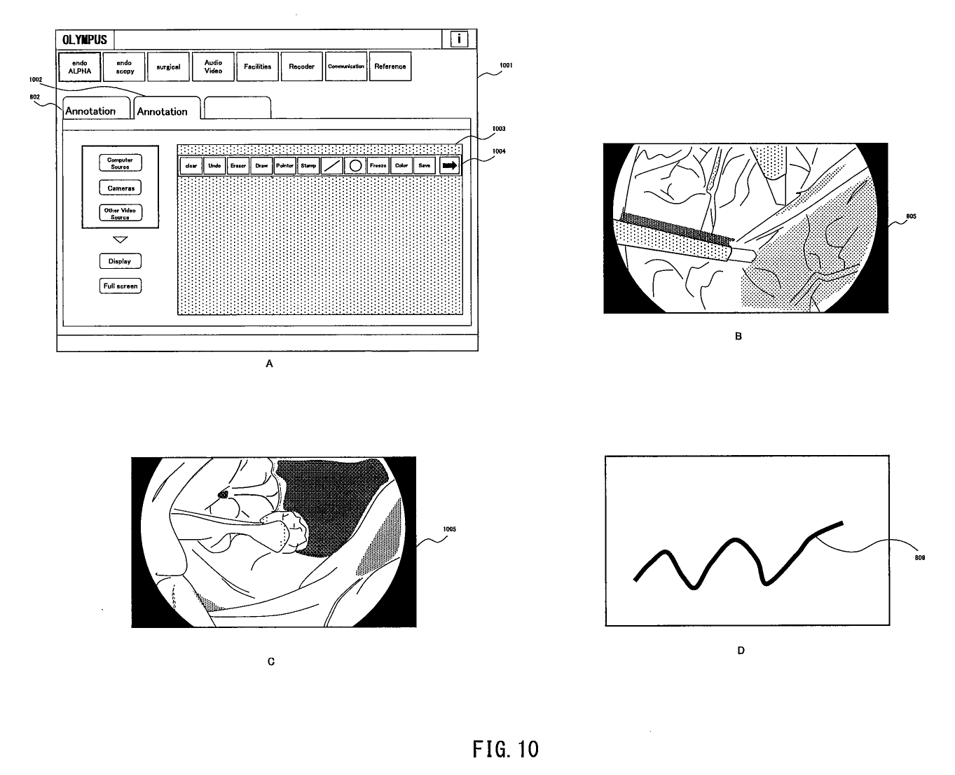

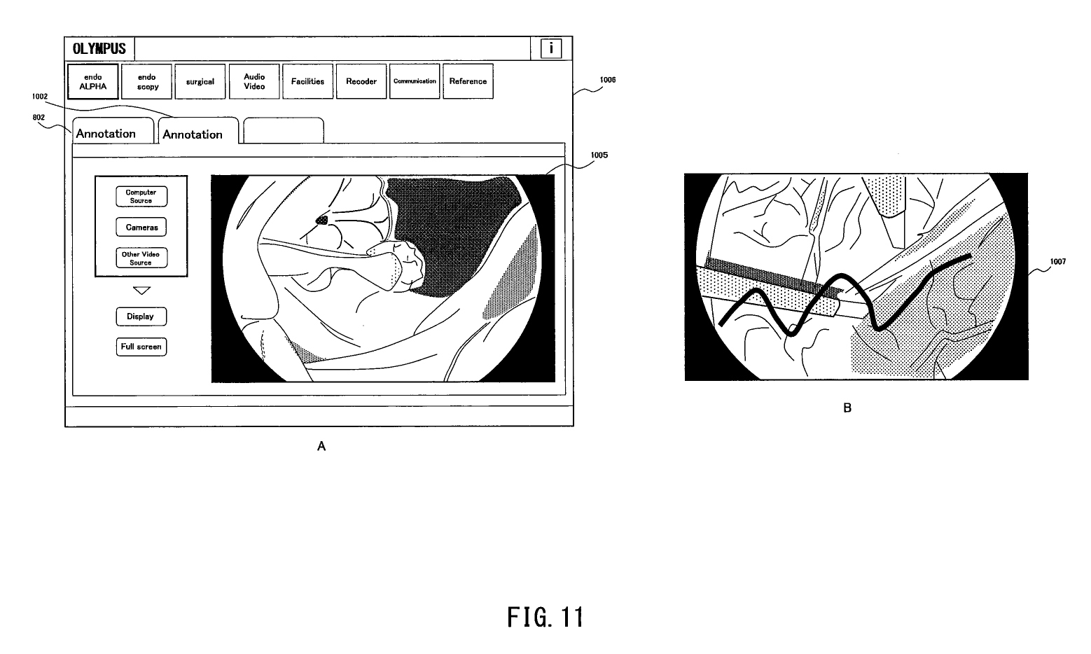

FIGS. 10 and 11 show a case when another window is opened.

As an example, a case is shown in which the edition of the GUI image 801 (“Annotation”: superposition image creation window) shown in FIG. 9C is completed, and a GUI image 1001 (“recording device manipulation window”) that is the next window shown in FIG. 10A is displayed. Also, a case is shown in which the image 805 shown in FIG. 10B is changed to a medical image 1005, shown in FIG. 10C.

The GUI image 1001 is an image of the output 709 of the GUI input interface unit 701. In the example of FIG. 10, the GUI image 1001 has a “Setting Recorder” selection switch 1002 used for selecting operation windows, an image region 1003 used for outputting medical images, and an edit operation selection section that is a “menu bar” used for selecting an edit operation of the medical images.

FIG. 10B shows the same image as is shown in FIG. 8B, and is an image of the output 7010 of the first video input interface unit 702. Also, the medical image 805 is a single medical image input through the VIC 304.

The image 1005 shown in FIG. 10C is an image of an output 7011 of the second video input interface unit 703. Also, the medical image 1005 is a single medical image input through the VIC 304. Also, the medical images may be images that were image-processed by the VPC 307.

The drawing image 809 shown in FIG. 10D is a drawing image drawn by a user by using a device such as the TPs 113 or 221 before performing image processing by using the GUI image 1001. The drawing information of the drawing image is held in the memory device 704 (drawing information storage means).

A synthetic image 1006, shown in FIG. 11A, is an image of the output 7012 of the control unit 706, and is created by synthesizing, by using the image processing unit 705, the GUI image 1001 obtained through the GUI input interface unit 701 and the medical image 1005 obtained through the second video input interface unit 703.

The synthetic image 1006 shown in FIG. 11A is displayed in the TPs 113 and 221 or the like, and the medical image 1005 is displayed in the image region 1003.

FIG. 11B shows an image to be output to the display device 220. The image 1007 is an image of the output 7013 from the output means 708. It is an image obtained by superposing the medical image 805 obtained through the first video input interface unit 702 and the drawing image 809 stored in the memory device 704.

As described above, by using the TPC 306, even when the TP 113 or 221 displays a different window, the superposition images whose edit is currently being performed or whose edit has been completed can be displayed.

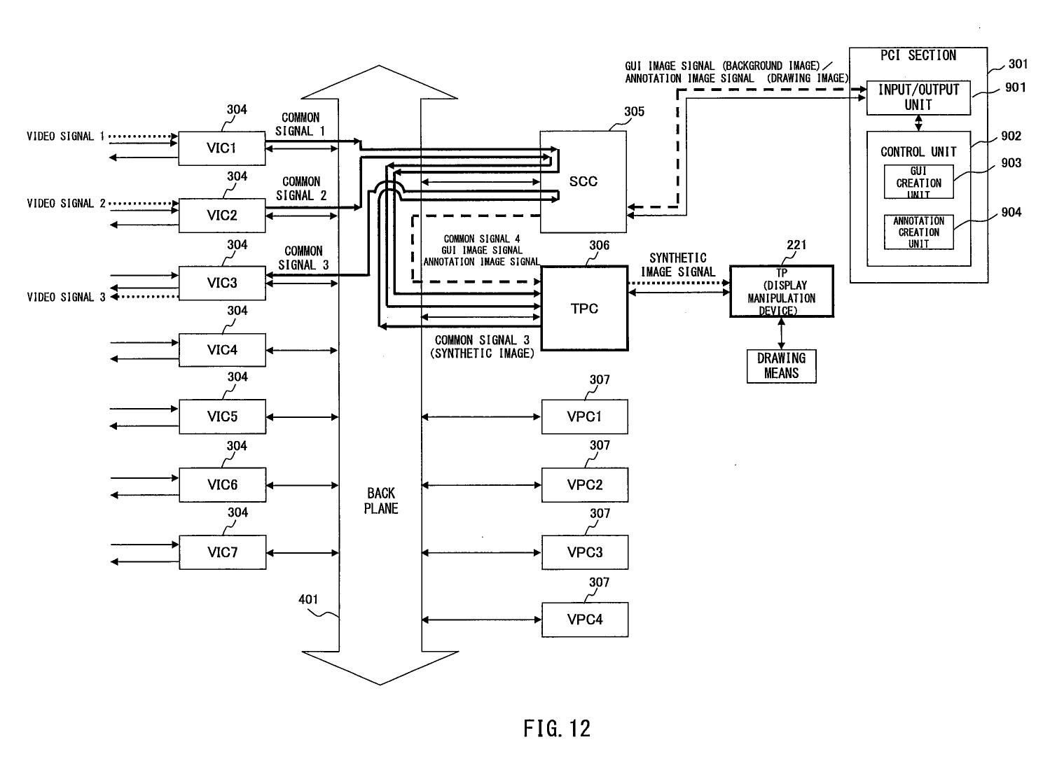

FIG. 12 shows a flow of signals of the respective image signals when an image edit is performed.

The users select a medical image to be edited by using the TP 221 and an output-destination display device (such as the display device 220).

In FIG. 12, a medical image 1 that is transmitted from a plurality of the medical devices (such as the endoscopes) is selected, and an output-destination display device connected to the VIC3 304 is selected.

For example, it is assumed that the GUI image to be displayed on the TP 221 is the GUI image 801, and that the selected medical image 1 is the medical image 805. The medical image 805 is displayed in the image region 803 (FIG. 8A: Annotation) in the display window of the TP 221.

The medical image 1 is input to the VIC1 304 as a video signal 1 (represented by a dotted line), and is converted into a common signal 1 in the VIC1 304. The common signal 1 (represented by a solid line) is input into the SCC 305 via the back plane 401, and thereafter is input into the TPC 306.

The GUI images are created in a GUI creation unit 903 in the control unit 902 (such as the CPU or the like) in the PCI section 301, and are transferred to the SCC 305 via an input/output unit 901. The GUI image obtained in the SCC 305 is transferred to the TPC 306 via the back plane 401.

The GUI image 801 and the medical image 805 are synthesized by the TPC 306, and the synthetic image 806 shown in FIG. 8C is displayed in the TP 221. Also, the image 807 in the image region 803 of the synthetic image 806 is converted into a common signal 3, and is output to the VIC3 304 via the SCC 305. In this configuration, the edit operation selection section 804 is included in the output synthetic image 807.

Next, the user performs drawing on the medical image 805 by using drawing means (such as a mouse) in the TP 221, and the synthetic image 806 shown in FIG. 9C is displayed on the TP 221.

The drawing image 809 displayed in the synthetic image 806 is created in an annotation creation unit 904 in the control unit 902 (such as the CPU or the like) in the PCI section 301 on the basis of the coordination information transmitted from the TP 221 to the PCI section 301. Then, the created drawing image 809 is transmitted as the GUI image signal/annotation image signal to the SCC 305 via the input/output unit 901 together with the GUI image 801 (including the edit operation selection section 804). The GUI image signal/annotation image signal obtained in the SCC 305 is transferred to the TPC 306 via the back plane 401.

The superposition images 808 obtained by superposing the drawing image 809 on the GUI image 801 and on the medical image 805 are synthesized by the TPC 306, and a synthetic image 8010 shown in FIG. 9C is displayed in the TP 221.

The superposition image 808 of the image region 803 of the synthetic image 8010 is converted into a common signal 3 (represented by a solid line), and is output to the VIC3 304 via the SCC 305. In this configuration, the edit operation selection section 804 is included in the output synthetic image 8010.

Next, from the edit using the GUI image 801, the GUI image 1001 (recording device manipulation window) shown in FIG. 10A is displayed

In FIG. 12, a medical image 2 that is transmitted from a plurality of the medical devices (such as the endoscopes) is selected.

For example, it is assumed that the GUI image to be displayed on the TP 221 is the GUI image 1001, and the selected medical image 2 is the medical image 1005. The medical image 1005 is displayed in the image region 1003 (FIG. 11A: recording device manipulation window) in the display window of the TP 221.

The medical image 2 is input into the VIC2 304 as a video signal 2 (represented by a dotted line), and is converted into a common signal 2 in the VIC2 304. The common signal 2 (represented by a solid line) is input into the SCC 305 via the back plane 401, and thereafter is input into the TPC 306.

The GUI image 1001 is created in the GUI creation unit 903 in the control unit 902 (such as the CPU or the like) in the PCI section 301, and is transferred to the SCC 305 via the input/output unit 901. The GUI image signals obtained in the SCC 305 is transferred to the TPC 306 via the back plane 401.

The GUI image 1001 and the medical image 1005 are synthesized by the TPC 306, and a synthetic image 1006, shown in FIG. 11A, is displayed in the TP 221.

Also, when an edit is being performed by using the synthetic image 1006, the image 1007 shown in FIG. 11B made using the medical image 805 and the drawing image 809 stored in the memory device 704 is converted into the common signal 3 (represented by a solid line), and is output to the VIC3 304 via the SCC 305.

The image 1007 is output in a state in which the edit operation selection section 804 is erased from the superposition image 808 in FIG. 9.

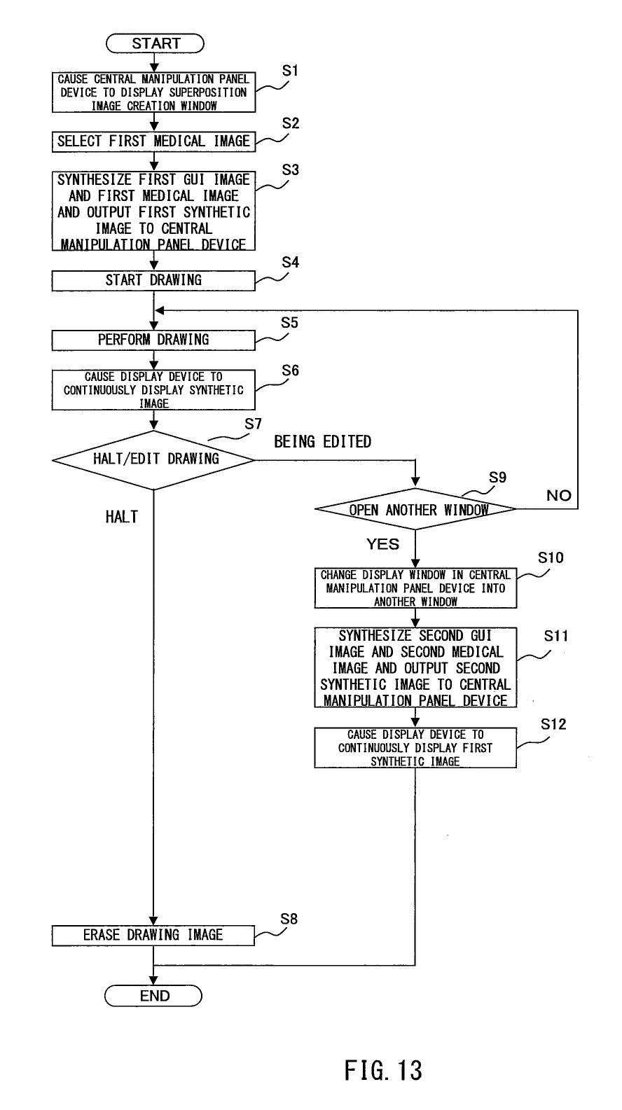

FIG. 13 is a flowchart for a process of synthesizing the GUI image obtained through the GUI input interface unit 701 and the medical image obtained through the first video input interface unit 702 and the second video input interface unit 703.

In step S1, the display window in the TP 221 displays an edit window (such as the superposition image creation window). For example, users perform editing while viewing the first GUI image (GUI image 801) shown in FIG. 8 that is displayed in the TP 221 or the synthetic image 806. In this configuration, the transition to the edit window is made when the “Annotation” selection switch 802 shown in FIG. 8 is selected.

In step S2, the first medical image (medical image 805) to be displayed in a plurality of display devices is selected. For example, an image of the corresponding endoscope is displayed.

In step S3, a first synthetic image (synthetic image 806) obtained by synthesizing the first GUI image and the first medical image by using the TPC 306 is output to the TP 221.

In step S4, drawing starts. For example, the edit operation selection section 804, i.e., a “menu bar”, for selecting the edit operation on medical images is displayed.

In step S5, drawing is performed. For example, a drawing image such as the drawing image 809 shown in FIG. 9A is displayed. Then, the superposition image 808 shown in FIG. 9C is displayed in the TP 221. When the edit on the superposition image 808 performed by the user is completed, the superposition image 808 is displayed in the display device 220.

In step S6, the display device 220 continuously displays the superposition image 808.

In step S7, it is determined whether the drawing was halted or has continued. When it is determined that the drawing was halted, the process proceeds to step S8. Further, when another window is to be opened, the process proceeds to step S9.

In step S8, the drawing image is erased. For example, the drawing image 809 is deleted.

In step S9, it is determined whether or not another window was opened. When a transition to another window is to be made, the process proceeds to step S10. Further, when an edit is to be performed on the first synthetic image, the process proceeds to step S5.

In step S10, the TP 221 displays the second GUI image, which is another window. For example, the GUI image 1001 as shown in FIG. 10A is opened. The second GUI image is displayed when the “Setting Recorder” selection switch 1002 is selected.

In step S11, the second synthetic image (synthetic image 1006) obtained by synthesizing the second GUI image and the second medical image by using the TPC 306 is output to the TP 221. A second medical image (medical image 1005) to be displayed in a plurality of display devices is displayed. For example, an image of the corresponding endoscope is displayed.

In step S12, the display device is caused to continue to display the superposition image 808.

Conventionally, the superposition images were displayed only in the TP 221. However, in the present invention such images are also displayed in the display device 220 or the like. Also, it is possible to distribute the superposition images not only to the display device 220, but also to a plurality of other display devices.

Further, conventionally, when the edit window (such as the superposition image creation window or the like) in which a superposition image is being created transits to another window, the superposition image that is in the display device 220 was deleted; however, in the present invention the superposition image can be continuously displayed in the display device 220 even when the edit window transits to another edit window.

Also, when an edit window in which a superposition image is being edited has transited to another edit window, it has conventionally not been able to pre-view the medical images or the like to be edited in the other edit window. However, in the present invention it is possible to display the medical images to be edited in the TP 221 while it is being edited.

The scope of the present invention is not limited to the above embodiments, and various alterations and modifications are allowed without departing from the spirit of the present invention.

What is claimed is:

1. A control device connected to a display manipulation device and a plurality of display devices, comprising:
superposition means creating a superposition image that is obtained by super posing drawing information on an image of an input video signal; and
output means outputting, to the respective display devices, the superposition image and an image that is different from an image in the display manipulation device.

2. The control device according to claim 1, wherein:
the control device is a medical support control system; and
the input video signal is a medical image.

3. The control device according to claim 1, wherein:
when the image is a menu bar and the menu bar and the superposition image are displayed in a superposed state, the menu bar is erased, and the superposition image is stored.

4. A control system having at least a display manipulation device and a plurality of display devices, comprising:
superposition means creating a superposition image that is obtained by superposing drawing information on an image of an input video signal; and
output means outputting, to the respective display devices, the superposition image and an image that is different from an image in the display manipulation device.

5. The control system according to claim 4, wherein:
on the basis of an output destination set by the display manipulation device, the output means outputs, to the respective display devices, a synthetic image obtained by synthesizing the superposition image and the image.

6. The control system according to claim 5, wherein:
even when a superposition image creation window displayed in a manipulation window in the display manipulation device has transited to another window, the output means causes the display device to display the synthetic image.

7. The control system according to claim 6, wherein:
the control system further comprises:
drawing information storage means storing the drawing information; and
even when a superposition image creation window displayed in a manipulation window in the display manipulation device has transited to another window, the output means continues to cause the display device to display the synthetic image on the basis of the drawing information stored in the drawing information storage means.

8. The control system according to claim 1, wherein:
the control system further comprises:
drawing means for creating the drawing information.

9. The control system according to claim 7, wherein:
the drawing means is the display manipulation device or a mouse.
